(19) United States
(12) Patent Application Publication
(10) Pub. No.: US 2002/0179316 A1
(43) Pub. Date: Dec. 5, 2002

(54) Protective cover for electronic devices

(76) Inventor: Steve Freedman, Stanton, CA (US)

Correspondence Address: DRUMMOND & DUCKWORTH, Suite 500, 4590 MacArthur Blvd., Newport Beach, CA, 92660, US

(21) Appl. No.: 09/871,548

(22) Filed: May 30, 2001

(51) Int. Cl. H02G 3/08

(52) U.S. Cl. 174/50

(57) ABSTRACT

A hard cover for protecting electronic devices is provided. The hard cover includes a horizontally extending planar member, a pair of vertically extending sidewalls, and a pair of horizontally extending flanges. The sidewalls attach to the ends of the planar member to form a central cavity sized and positioned for receiving an electronic device, such as a six-sided portable computer. The flanges extend outwardly from the bottom edges of the sidewalls.

The hard cover is intended as supplemental protection for protecting an electronic device within a separate carrying bag, particularly a soft-sided carrying bag.

### BACKGROUND OF THE INVENTION

The present invention relates generally to devices for protecting and carrying electronic devices. More particularly, the present invention relates to a device for protecting portable personal computers such as laptop computers and notebook computers. For simplicity and clarity, laptop-type and notebook-type portable personal computers will be referred to herein collectively as portable computers.

In recent years, the size and weight of portable computers have dramatically decreased which has facilitated their portability. To allow the portable computers to be conveniently carried by the owner, carrying cases are typically used which include straps and/or handles. Recognizing the relative sensitivity of personal computers to damage, these carrying cases are usually constructed to provide some degree of protection to the portable computer. This protection must be provided to protect against dropping, rapid acceleration or deceleration, or the computer being struck by a moving object.

A variety of carrying cases have been developed for carrying and protecting portable computers. Some conventional carrying cases have outer hard shells with interior padding that is intended to deform upon impact to protect a portable computer. Other types of conventional portable computer carrying cases which afford less protection to the computer are constructed of soft fabric and have interior padding. Unfortunately, these “soft” carrying cases, though typically lightweight, do not provide a sufficient level of protection to a personal computer during traditional business travel.

U.S. Pat. No. 5,725,090 naming Vermillion et al. as the inventor and International Patent Application No. PCT/US93/04953 naming Hollingsworth as the inventor disclose partially hard carrying cases for carrying laptop computers. Within the carrying cases are flexible slings for positioning the laptop computer within the case. Meanwhile, U.S. Pat. No. 5,678,666 naming Shyr et al. as the inventor discloses a partially hard carrying case having a detachable soft interior case held in place by velcro attachments. U.S. Pat. No. 5,857,568 issued to Speirs discloses a briefcase adaptor for protecting and positioning a laptop computer within a briefcase. The adaptor includes parallel frame members which surround the periphery of a laptop computer but do not provide any protection for the top and bottom of the computer. In addition, U.S. Pat. No. 5,570,780 naming Miller as the inventor discloses a hard carrying case for protecting laptop computers. The carrying case includes inflatable bladders along the case's sidewalls which are intended to be inflated to provide cushioning to the computer.

Attempts have been made to construct protective devices which are intended to supplement the protection of a carrying bag. For example, U.S. Pat. No. 5,775,497 discloses a protective case having a plurality of cushioned and rigid sideboards which are connected by velcro straps. The entire case is intended to be inserted into a business case, backpack or briefcase for carrying the personal computer. Unfortunately, the supplemental protective case does not provide protection to the sidewalls of a computer. Similarly, U.S. Pat. No. 5,529,184 naming Sadow as the inventor discloses a protective shield for laptop computers. The shield includes a rectangular frame having an interior flexible diaphragm. Two of such protective shields are velcroed on each side of a laptop computer before placing the entire structure within a hard or soft carrying case.

Unfortunately, present hard cases for protecting portable computers are typically very heavy and very expensive. Conversely, soft carrying bags for portable computers are lightweight but typically do not provide sufficient protection for a portable computer against inadvertent falls, or impact with other objects. Thus, it would be advantageous to provide a carrying case for portable computers that provides the lightweight benefits of a soft carrying bag with the protection typically only offered by hard carrying cases.

It is an additional object of the present invention to provide a carrying case which is inexpensive to manufacture and easy to use by the personal computer owner.

### SUMMARY OF THE INVENTION

In accordance with the invention, I provide a substantially hard cover for providing supplemental protection to electronic devices, such as portable computers, carried within carrying bags, particularly soft carrying bags. Moreover, I have constructed the hard cover to provide primary protection for the display screen of the laptop computer.

Most elements of a laptop computer are constructed to withstand significant vibration, shock, impact forces and acceleration or deceleration. In fact, most components of a laptop computer will survive an instance where a laptop computer has dropped a significant distance, or an incidence where the laptop computer has been struck by an object. However, this cannot be said about typical display screens for portable computers. The display screen is typically the most fragile element of a portable computer. Only a small amount of vibration, or small impact of an object on the top of the laptop computer behind the display screen, will cause the display screen to crack and the portable computer to become unusable. Unfortunately, this most fragile component of a portable computer is also by far the most expensive component to replace. In comparison, virtually every component other than the display screen of a portable computer can be replaced for a relatively inexpensive amount. Due to the sturdiness and relative inexpense in replacing or fixing these other computer components, such as the keyboard, hard drive, floppy drive, processor, etc., a portable computer does not justify purchasing an expensive or heavy carrying case. Conversely, the portable computer display screen is the most fragile component of the computer and also perhaps is the most expensive component to fix or replace. Typically, replacement of the display screen costs thousands of dollars, often more than the replacement cost of the entire portable computer.

For these reasons, the hard cover of the present invention is constructed to provide primary protection to the portable computer display screen. Significant costs are eliminated and weight savings are obtained by providing primary protection only to the display screen which is prone to damage or which is expensive to replace.

The hard cover is preferably constructed of a hard material such as a metal including steel, aluminum or titanium. Alternative acceptable materials include hard plastics or composite materials such as fiberglass, kevlar or carbon fiber. The hard cover includes a planar member sized to protect the top side of a folded and stowed portable computer. This planar member is positioned behind the display screen of the laptop computer and provides protection against damage to the display screen caused by dropping of the computer, or objects striking the back of the display screen.

The hard cover of the present invention also includes a pair of sidewalls which extend downwardly from opposing ends of the planar member. The sidewalls are sized to cover and protect the sides of a portable computer. Preferably, the hard cover also includes a pair of outwardly extending flanges. Each flange attaches to a bottom extremity of the sidewalls, opposite to where the side wall engages the planar member. The flanges may be of various lengths, as can be determined by those skilled in the art, and are provided so as to centrally position the hard cover of the present invention and portable computer within the soft carrying bag.

Preferably, the hard cover includes three or more pieces of deformable padding. The pieces of padding are affixed by glue or other adhesive to the interior surfaces of the planar member and sidewalls so that a portable computer positioned within the cavity formed by the planar member and sidewalls does not directly engage any of these hard surfaces. Instead, the padding, preferably constructed of rubber or similar material for cost reasons, provides protection against the hard surfaces of the cover of the present invention engaging directly upon the exterior of the portable computer. The padding also dampens any shock or vibration imparted from the hard cover to the portable computer.

To use the hard cover of the present invention, a stowed portable computer is placed in a carrying bag of typical construction with the backside of the display screen facing upwardly. The hard cover including a top planar member, sidewalls and outwardly extending flanges is placed into the carrying bag with the portable computer being received within the cover's central cavity. The flanges extend outwardly to inhibit movement of the portable computer or hard cover within the soft carrying bag. Preferably, the carrying bag is constructed of reinforced soft fabric, and includes straps, such as velcro straps for further preventing movement of the portable computer and hard cover within the carrying bag.

It is an object of the present invention to provide a device for protecting portable computers during travel.

It is another object of the present invention to take advantage of the advantages of both hard carrying cases and soft carrying bags for use in carrying portable computers.

It is still an additional object of the present invention to provide a device for protecting portable computers which is both lightweight and provides primary protection to the display screen of a portable computer.

These and other specific objects and advantages of the invention will be apparent to those skilled in the art from the following detailed description taken in conjunction with the drawings.

### BRIEF DESCRIPTION OF THE DRAWINGS

FIG. 1 is a frontal perspective view of the protective cover of the present invention illustrating the mode in which the protective cover is placed onto a portable computer;

FIG. 2 is a rear elevation view of the protective cover of the present invention;

FIG. 3 is a top view of the protective cover of the present invention;

FIG. 4 is a front elevation view of the protective cover of the present invention;

FIG. 5 is a right elevation view of the protective cover of the present invention;

FIG. 6 is a bottom plan view of the protective cover of the present invention;

FIG. 7 is a left elevation view of the protective cover of the present invention;

FIG. 8 is a frontal perspective view of the present invention illustrating the mode in which the protective cover is placed onto a portable computer and then placed within a carrying bag.

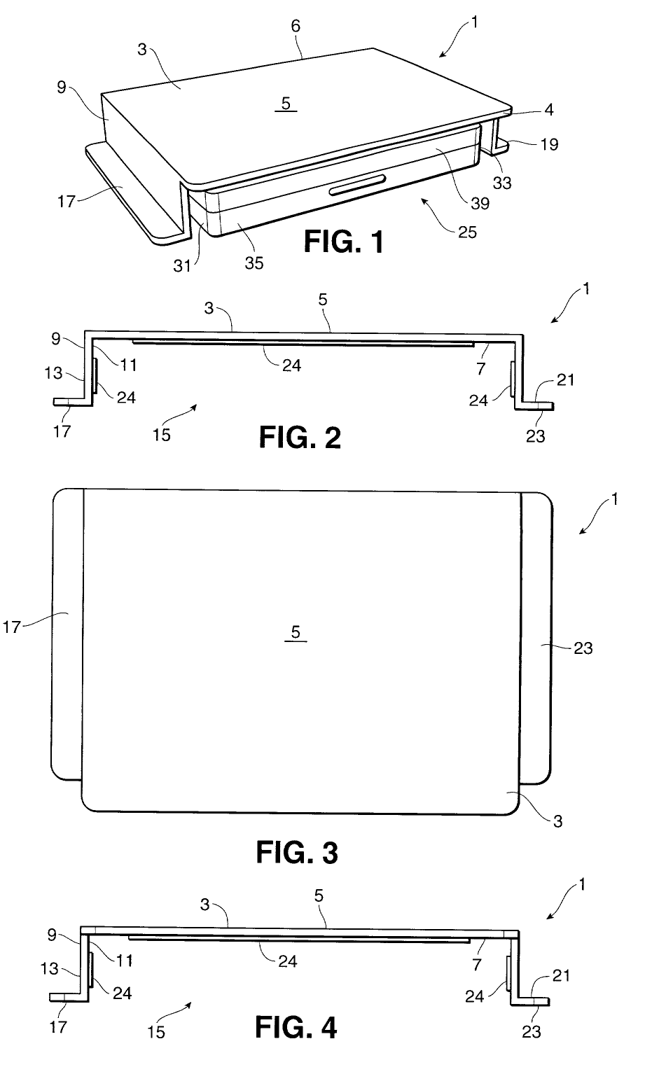

### DETAILED DESCRIPTION OF THE INVENTION

While the present invention is susceptible of embodiment in various forms, as shown in the drawings, hereinafter will be described the presently preferred embodiments of the invention with the understanding that the present disclosure is to be considered as an exemplification of the invention, and it is not intended to limit the invention to the specific embodiments illustrated.

As shown in the figures, the hard cover 1 of the present invention is directed to protecting electronic devices, primarily electronic devices such as portable computers having six sides including top, bottom, left 31, right 33, front 35 and back sides. The hard cover 1 may be constructed of any hard material. However, sheet metals including steel or aluminum are considered preferable. Other acceptable materials include titanium, hard plastics, or composite materials.

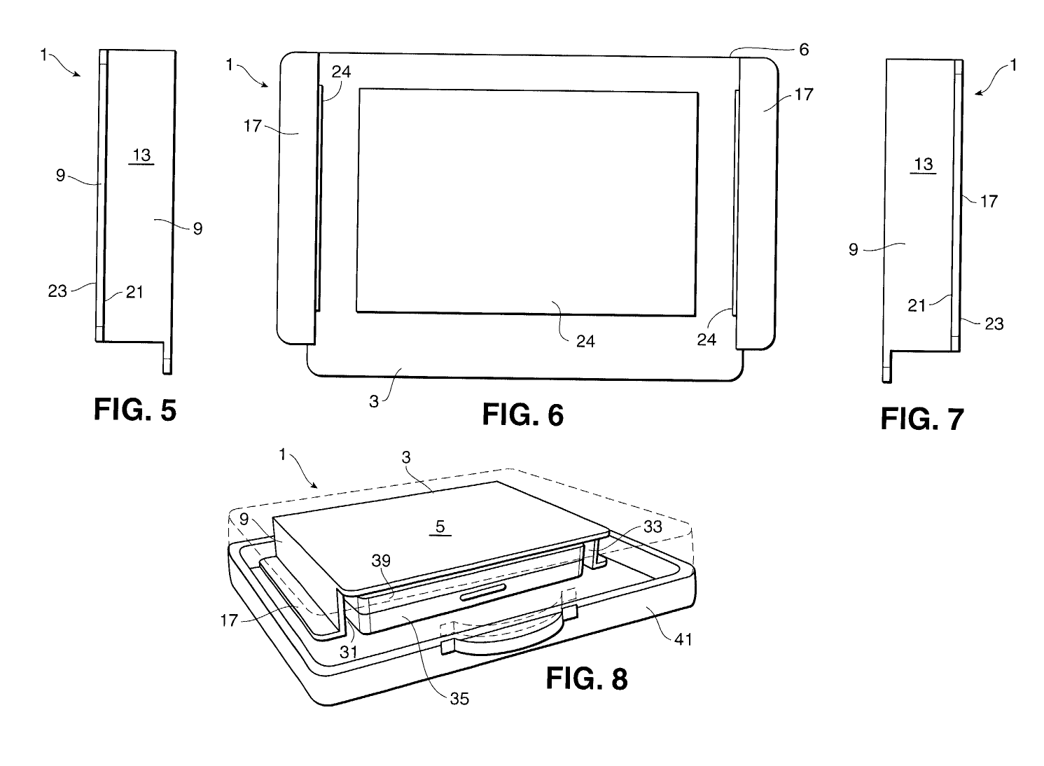

With reference to FIGS. 2-7, the hard cover 1 includes a planar member 3, a pair of sidewalls 9, and a pair of flanges 17. The planar member 3 has a top surface 5 and a bottom surface 7 and is substantially rectangular being sized and constructed to cover the top surface of an electronic device 25. In a preferred embodiment, and as shown in the Figures, the electronic device is a portable computer. Extending downwardly from opposite sides of the planar member are the sidewalls 9. The sidewalls are also substantially planar and include an inside surface 11 and outside surface 13. Preferably, the sidewalls extend in the direction perpendicular to the plane of the planar member 3 to form a central cavity 15. Meanwhile, the flanges 17 extend outwardly from the bottom ends of the sidewalls 9. The flanges 17 are positioned to be perpendicular to the sidewalls 9 and parallel to the planar member 3. Each flange 17 includes a top surface 21 and bottom surface 23.

Preferably, the hard cover 1 of the present invention includes three pieces of padding 24 adhered to the interior surfaces of the sidewalls and planar member, respectively. The padding may be constructed of individual rubber strips extending substantially along the length and width of the planar member and sidewalls. Alternatively, the padding may include numerous separate elements attached to the sidewalls or planar member. With reference to FIG. 3, the sidewalls 9 and flanges 17 may extend longitudinally the entire length of the planar member 3. Alternatively, the planar member may extend further longitudinally than the sidewalls 9 and flanges 17, as shown in FIG. 3, to form an overlapping edge. Moreover, the planar member may include back and/or front lips (not shown) which extend downwardly to cover the upper edges of the electronic device 35. The lips also serve to maintain the hard cover centrally over the electronic device.

With reference to FIG. 8, to use the hard cover 1 of the present invention, an electronic device 25 is placed within a separate carrying bag 41. To save weight, and because the hard cover provides primary protection to the electronic device, preferably the carrying bag is constructed of a soft material such as a reinforced leather, nylon or cotton. Where the electronic device is a portable computer, the display screen 39 is positioned above the rest of the portable computer so that the back side of the display screen faces upwardly. The hard cover 1, including planar member, sidewalls and flanges, is then placed in the carrying bag with the portable computer being received within the cover's central cavity 15. The planar member is positioned so that its front edge 4 and rear edge 6 are aligned with the front and back of the portable computer so that the display screen 39 is completely covered by the planar member 3. Preferably, the carrying bag 41 includes velcro straps (not shown) for affixing the portable computer and hard cover in place. The carrying bag can then be closed and transported with the portable computer and its display screen being protected against inadvertent falls, unintended jostling, or being struck by other objects. Having described my invention in such terms to enable those skilled in the art to make and use it, and having identified the presently preferred embodiments thereof,

I claim:

1. A substantially hard cover for protecting electronic devices having six sides such as personal, portable computers, the hard cover comprising:
a planar member sized and constructed to substantially cover and protect a top side of an electronic device;
a pair of downwardly extending sidewalls sized and constructed to cover and protect two sides of the electronic device; and
a pair of outwardly extending flanges, each of said flanges attaching to the bottom extremities of said sidewalls and extending outwardly;
said cover being sized and constructed to cover and protect the electronic device within a separate carrying bag.

2. A substantially hard cover and soft carrying bag combination for protecting electronic devices having six sides, the hard cover and carrying bag combination comprising:
a carrying bag having an interior and an opening for placing objects within said interior; and
a hard cover removable from said soft carrying bag including,
a planar member sized and constructed to substantially cover and protect a top side of an electronic device; and
a pair of downwardly extending sidewalls sized and constructed to cover and protect two sides of the electronic device;
a pair of outwardly extending flanges, each of said flanges attaching to the bottom extremities of said sidewalls and extending outwardly; and
said cover being sized and constructed to cover and protect the electronic device within a separate carrying bag.
